(19) United States
(12) Patent Application Publication
(10) Pub. No.: US 2003/0009902 A1
(43) Pub. Date: Jan. 16, 2003

(54) Compact and portable apparel drying apparatus

(76) Inventor: Ronald E. Kirk, Ontario, OR (US)

Correspondence Address: PEDERSEN & COMPANY, PLLC, P.O. BOX 2666, BOISE, ID, 83701, US

(21) Appl. No.: 10/112,073

(22) Filed: Mar. 28, 2002

Related U.S. Application Data
(60) Provisional application No. 60/280,348, filed on Mar. 28, 2001.

(51) Int. Cl. F26B 25/00

(52) U.S. Cl. 34/104; 34/106

(57) ABSTRACT

This invention is a compact, portable apparel drying apparatus that comprises a base having two ends with a cross-member midway between these ends. An apparel holding frame is pivotally connected to each end of the base. Two support arms are provided, one end of each is removably connected to one of the apparel holding frames. The other ends of the support arms are pivotally connected to the base cross-member. When connected, the support arms securely position the apparel holding frames at an inward angle of approximately 75 degrees with respect to the base. When the support arms are disconnected from the holding frames, they fold compactly to lie flush with the base. The base, the apparel holding frames and the support arms may be formed from any durable material such as stainless steel rod or high temperature plastics.

### DESCRIPTION

This application claims priority of prior, co-pending provisional patent application, Serial 60/280,348, filed on Mar. 28, 2001, entitled “Compact and Portable Apparel Drying Apparatus,” which is incorporated herein by reference.

### BACKGROUND OF THE INVENTION

1. Field of the Invention

This invention relates generally to devices for drying articles of clothing, and more specifically to compact and portable drying apparatus.

2. Related Art

The prior art going back over 100 years is replete with clothing, boot and glove dryers designed primarily for home use. These dryers tend to be bulky and difficult to store when they are not needed. All are unsuitable for use while camping, hiking, backpacking or participating other outdoor applications.

The vast majority of the prior art offers designs that include some means for capturing air that has been heated and then providing a means for ducting the heated air to the article of clothing to be dried. For example, in 1899 Witmer (U.S. Pat. No. 629,944), discloses a sheet metal boot drier having a pair of tubes extending upward from openings in a lower plenum, the tubes being positioned to received the inverted boots to be dried. In use the plenum collects air heated by a lamp which is transferred to the tubes to heat and thus dry the boots. Although Witmer's design is suitable for outdoor use, it is not sufficiently compact for efficient storage easy transport.

A few years later, Peabody discloses in (U.S. Pat. No. 859,514) a truncated conical boot drying apparatus. The base of the sheet metal cone is placed on a heated surface and a single boot is inverted and placed over the upper portion of the cone. Air holes are provided near the base of the cone to admit air to the interior of the cone which is then heated and carried to the interior of the boot by convection. To promote air circulation through the interior of the boot, Peabody provides an upward projecting external U-shaped tube, one leg of which is affixed to the outside of the cone. The distal end of this leg extends into the boot. The other leg projects upward on the outside of the boot. In this fashion, heated air within the boot is exhausted downward through the leg attached to the side of the cone and then upward through the other leg. As in Witmer's design, Peabody's apparatus is not compact and is generally unsuitable for most outdoor applications.

A large number of non-portable and relatively bulky shoe, boot and glove drying devices have been disclosed that generally provide a means for gathering heated air from a home's floor or wall register and then ducting the heated air to the interior of the glove or boot. The ducting means typically supports the article of clothing to be dried. Examples of design patents of this nature include Donaldson (U.S. Pat. No. D194,512), Schenck (U.S. Pat. No. D213,129), Johnson (U.S. Pat. No. D310,742), Winkler (U.S. Pat. No. D322,344), Christensen (U.S. Pat. No. D347,094), Marks (U.S. Pat. No. 372,346), and Rask (U.S. Pat. No. 373,867).

Utility patents that also depend on a home's heating register in a manner very similar to the above described design patents include Masika (U.S. Pat. No. 4,085,519), Hay (U.S. Pat. No. 4,134,464), McCartney (U.S. Pat. No. 4,596,078) and Farrant (U.S. Pat. No. 5,946,814).

Petre (U.S. Pat. No. 4,530,168) discloses a combination boot carrying and drying device that removably attaches to a boot that in turn removably attaches to a wall bracket placed immediately above a home's heating register. The fixture, adjustable for different sized boots, may be used to carry the boots when they are not being dried.

In a somewhat different, but relevant, approach Antal (U.S. Pat. No. 5,692,316) discloses a plurality of shaped wire holding units that are positioned on at least two hardwood base pieces that provide stability for the assembled apparatus. The holding units are designed to rotate within the base pieces to allow the apparatus to be stored in a flattened position. The holding units are rotatably secured in vertical holes in the wooden base pieces by push nuts. The holding units are formed from wire in various shapes to accommodate different articles of apparel. This apparatus is designed to fit over air ducts (registers) and baseboard heaters. The apparatus further includes a means to adapt to various baseboard heights. Although Antal's disclosure is designed to be flattened for storage, from the nature of the relatively large hardwood base pieces, this invention does not have the portability and compactness required for easy transport and outdoor applications. In addition, the wooden base units could present a fire danger when used while camping.

Two utility patents teach apparel drying apparatus that do not depend on heated air from a home heating system. The first, Guindon (U.S. Pat. No. 5,058,289), describes a dryer having a base unit that incorporates a heating coil and a blower. The apparel, e. g. boots, are fitted over hollow, bellows type drying tubes. These tubes communicate with the interior of the base unit to receive forced, heated air to dry the apparel. The second approach by Jannach (U.S. Pat. No. 5,862,606) discloses a device for drying protective suits. This device consists of a plurality of hollow tubes formed to support the arms and legs of the suit in an inverted fashion. The tubes are connected to a blower which supplies heated air (the heat source is not disclosed). Holes in the tubes are provided at appropriate locations to vent the air after it has provided heat to the suit.

From the above discussion it is clear that there are no apparel drying devices that have the attributes required for compact storage and lightweight transport for camping, hiking, fishing and backpacking applications. For such applications an apparel dryer is needed for boots, shoes, gloves, mittens, and so forth is required that can readily be transported and erected by a single individual. As such this apparatus needs to be compact and lightweight yet rugged to withstand the rigors of outdoor use.

Thus it is a primary object of the extant invention to provide a drier for wearing apparel such as boots, shoes, gloves and other clothing that is may be compactly stored for easy transport, is rugged and yet lightweight, and is easy to set up for use.

It is another object of this invention to provide a compact, portable drier that may use the heat produced by camp stoves to dry the apparel. It is a further object of this invention that it may be used with conventional home heating units such as forced air registers and base board heaters.

It is yet another object of this invention to provide a compact, portable drier that is readily manufactured and produced at a very low cost.

### SUMMARY OF THE INVENTION

This invention is a compact, portable apparel drying apparatus that comprises a base having two end areas with a transverse area about midway between the two end areas. The end areas are for pivotal connection preferably of two apparel holding frames and the transverse area is for pivotal connection of preferably two support arms that support the apparel holding frames when the drying apparatus is unfolded for use.

The preferred base is an open frame, with two ends, two longitudinal side members, and a transverse cross-member midway between these ends. An apparel holding frame is pivotally connected to each end of the base, preferably by each being rotatably installed on an end member. Two support arms are provided, one end of each being removably connected to one of the apparel holding frames. The other ends of the support arms are pivotally connected to the base at the crossmember, preferably by being rotatably installed on the cross-member.

When connected to their respective apparel holding frames, the support arms securely keep each apparel holding frame in a position upending from the generally horizontal base, and most preferably, the support arms hold the apparel holding frames at an inwardly-inclined (acute) angle of approximately 45-80 degrees relative to the base, and, most preferably, about 75 degrees relative to the base.

When the support arms are disconnected from the holding frames, one apparel holding frame pivots inwardly to lie substantially flush with the plane of the base (on top of the base) and the second frame pivots outwardly and all the way around (typically greater than 270 degrees) to lie substantially flush with the other (bottom) side of the base. The disconnected support arms pivot to also lie flat against the base. In this manner a very compact storage configuration for the drier is provided, wherein the support arms may be coplanar with the base plane, and the apparel holding frames may be very close to being in the plane of the base, that is, in planes parallel to the base plane or in planes intersecting the base plane and only a couple degrees from the base plane.

In alternative embodiments, longer holding frames or frame extensions are provided to accommodate larger items such as hip and chest waders.

The base, the apparel holding frames, and the support arms may be formed from any durable material such as stainless steel rod or high temperature plastics. Preferably, the base end, side, and cross-members are all formed from elongated rod, and the apparel holding frames are also formed of elongated rods or wire, to produce an open, airy base and frame system that is conducive to air circulation around and inside the apparel, and that is light-weight and easily carried and stored.

Thus, embodiments of the invention may be described as an apparel drying apparatus comprising a generally flat base with two base ends, a base cross member approximately midway between the two base ends, an apparel holding frame pivotally connected to one of said base ends, a support arm with two arm ends, one end being removably connected to the apparel holding frame, and the other end being pivotally connected to the base cross member. Also, embodiment may be described as an apparel drying apparatus comprising a generally flat base with two base ends, a base crossmember approximately midway between the two base ends, an apparel holding frame pivotally connected to one of said base ends, a support arm with two arm ends, one end being pivotally connected to the apparel holding frame, and the other end being removably connected to the base crossmember. Further, there may be one apparel holding frame in such embodiments or a plurality of apparel holding frames. The apparel holding frames may be substantially identical to each other, or may have different distal ends for being adapted to different types of apparel, such as a boot, a hat, gloves, etc.. For example, an apparel holding frame for gloves could feature two narrow U-shaped extensions as the distal end of a single frame, one extension being for each glove, so that the frame is generally an upside-down W shape.

These and many other features and attendant advantages of the invention will become apparent as the invention becomes better understood by reference to the following detailed descriptions and accompanying drawings.

### BRIEF DESCRIPTION OF THE DRAWINGS

FIG. 1 is a top perspective view that shows one embodiment of the compact, portable apparel drying apparatus of the instant invention in use with a boot.

FIG. 2 is a top, perspective view that shows the embodiment of FIG. 1 compactly folded or “collapsed” for storage or convenient transport.

FIG. 3 shows details of one embodiment of pivotal connector that may be used in the embodiment of FIGS. 1 and 2.

FIG. 4A illustrates one embodiment of the apparel holding frame(s) of this invention.

FIG. 4B is a detail view of one embodiment for a connector on the frame of FIG. 4A that is adapted to removably hold an outer end of a support arm of the invented apparatus.

FIG. 5 illustrates a side view of the apparatus of FIG. 1 and 2 in a collapsed condition.

### DETAILED DESCRIPTION OF THE INVENTION

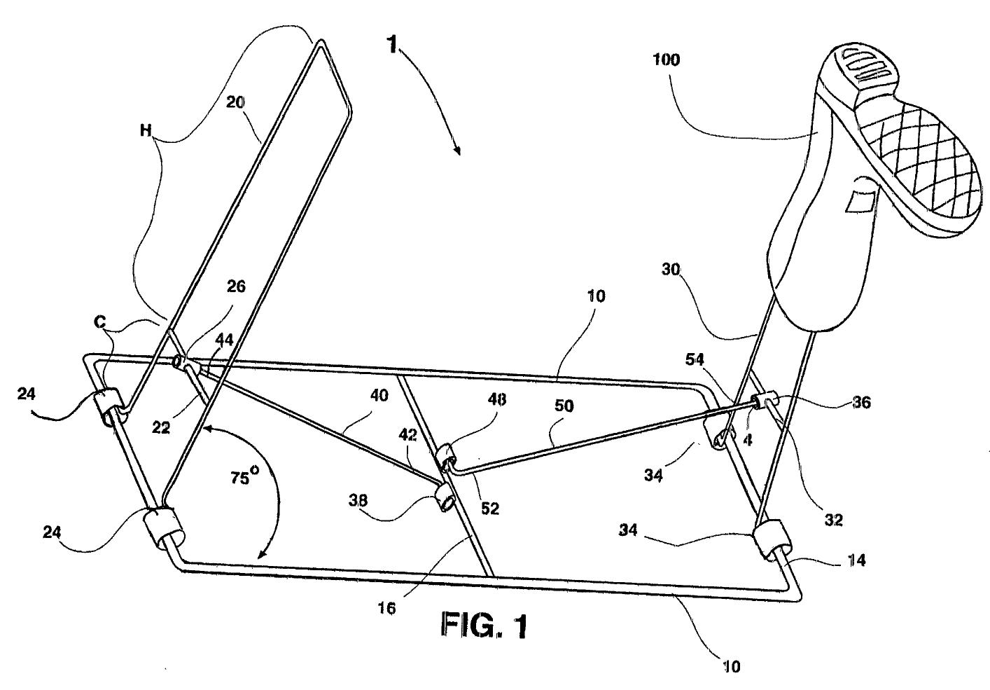

Referring to FIG. 1, this invention, a compact, portable apparel drying apparatus 1, comprises base 10 having first end 12, second end 14 and cross-member 16. First holding frame 20 is pivotally connected to first end 12 of the base by pivot connection system 24. Frame 20 also has first bracket 22. In a like manner, second holding frame 30 is pivotally connected to second end 14 of the base by pivot connection system 34. Frame 30 also has second bracket 32. Continuing reference to FIG. 1, first support arm 40 has first and second ends 42, 44. First end 42 is pivotally connected to base cross-member 16 by pivot connection system 48 and second end 44 is removably connected by connector 26 to first holding frame bracket 22. In a like manner, second support arm 50 has first and second ends 52, 54. First end 52 is pivotally connected by pivot connection system 58 to base cross-member 16 and second end 54 is removably connected by connector 36 to second holding frame bracket 32.

As shown in FIG. 1, when support arms 40,50 are connected to apparel holding frames 20, 30, the apparel holding frames are each securely maintained at an inward angle of approximately 75 degrees with respect to base 10. In this condition, the support arms are preferably also, therefore, at an angle to the base, in the range of about 20-45 degrees. The connectors 26, 36 are preferably located in about the lower ⅓ of the apparel holding frames (portion “C” in FIG. 1). This way, the upper approximate ⅔ of each holding frame (portion H in FIG. 1) extends up in a U-shape without any members extending through it, to it, or through its plane, and, thus, without such members interfering with placement of apparel and especially boots or footwear, over the frame.

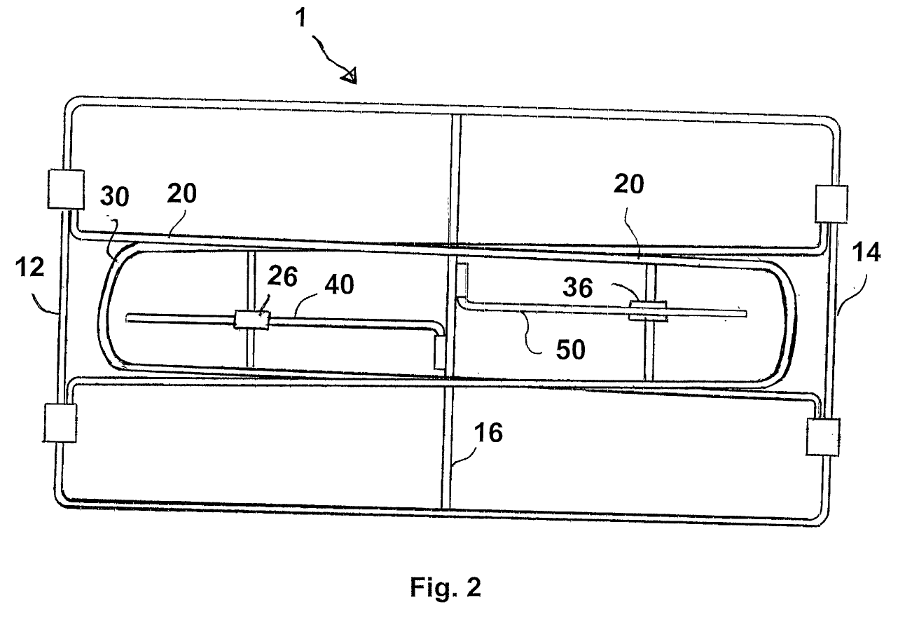

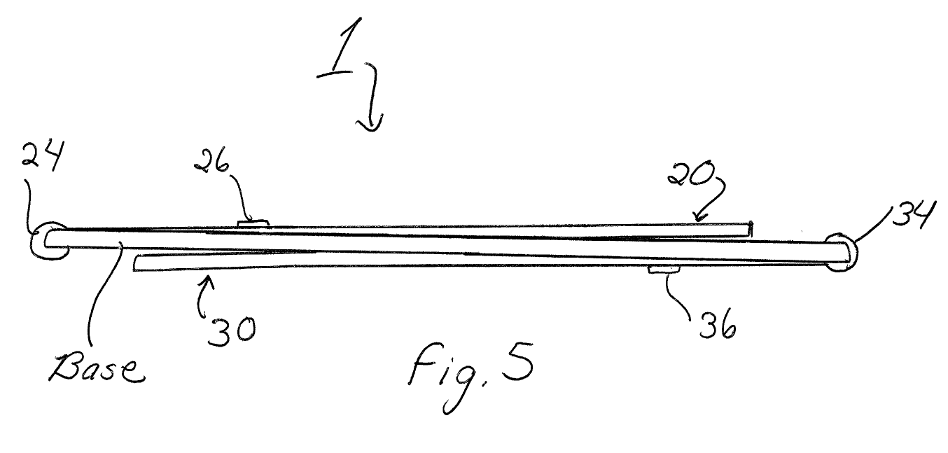

Referring now to FIG. 2, when the support arms are disconnected from connectors 26, 36 on the holding frames, one frame is folded downward to lie flush with the upper side of base and the other frame is rotated outwardly and around to lie flush with the lower or opposite side of the base. In this fashion, a very compact storage configuration is obtained for the drying apparatus. From this description and from the Figures, one may see that the apparel frames may not be exactly in the plane of the base, due to the slight interference caused by the crossmember. Because the frames and the base are preferably long in the longitudinal direction and because the preferred rod or wire forming the base and frames is relatively small in diameter, the frames, when collapsed against the frame are very close to being coplanar with the base. Because the support arms are preferably shorter than the distance between the crossmember and the ends of the base, the support arms may actually rotate to be coplanar with the base when the apparatus is collapsed. See, also, FIG. 5 as a side view of the preferred apparatus in collapsed condition.

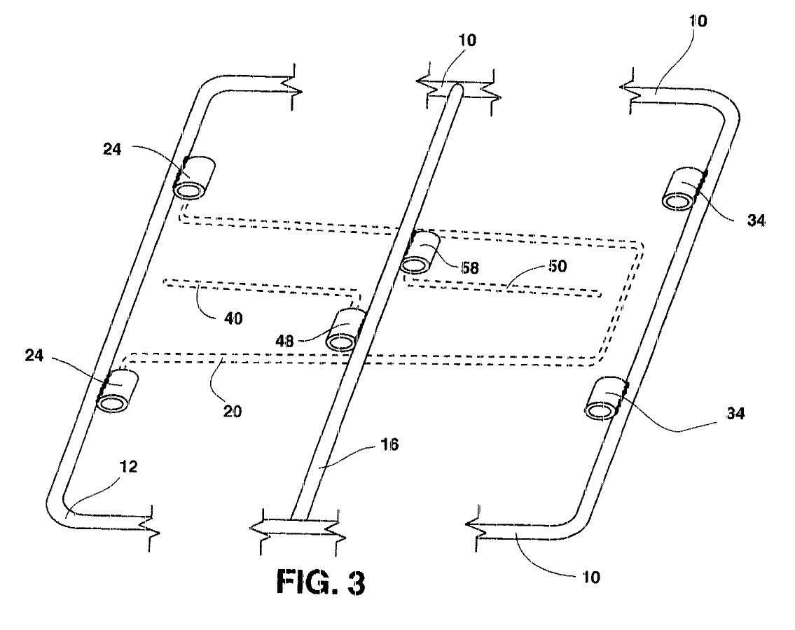

FIG. 3 shows additional detail of one embodiment of pivot connection systems 24, 34, 48 and 58. In this figure, to provide clarity, one holding frame (frame 20) and support arms 40,50 are shown in phantom in their stored positions. One may see that this preferred pivot connection system comprises short, generally tubular sleeves being provided parallel to the end members of the base and parallel to the crossmember. Two ends of each frame are rotatably received in two of these tubular sleeves on the end members, and one end of each support arm is rotatably received and retained in a tubular sleeve on the crossmember. The frames and support arms may be retained in their respective sleeves by various means for retaining, in effect, an axle member in a sleeve or bearing cylinder. For example, one may see that the frames are preferably captured between two of the sleeves and so are not easily removed from the base. Similarly, various means may be used to keep each support arm in its sleeve, as may be understood by one of skill after reading this Description and seeing the drawings.

In the preferred embodiment, base 10, holding arms 20,30, cross-member 16, support brackets 22, 32 and support arms 40, 50 are all formed from 0.5 cm diameter stainless steel rod. In an alternative embodiment, these components may be formed from a high strength, high temperature synthetic plastic material.

Referring again to FIGS. 1 and 2, base 10 is formed into a rectangular configuration from a single rod. The two ends of the rod forming the base are preferably welded together to form a single continuous piece. The rectangular base has a length of approximately 16 inches and a width of approximately 8.5 inches. Cross-member 16 is also preferably welded to the sides of the base midway between first and second ends 12,14, or at or approximately at midway, which may also be stated as “at or near midway”. Pivot means 24, 34, 48 and 58 are formed from stainless steel tubing and are welded to base 10. This tubing has an internal diameter of slightly more than 0.5 cm to allow smooth pivoting of the frames and support arms within the bore of the tubing.

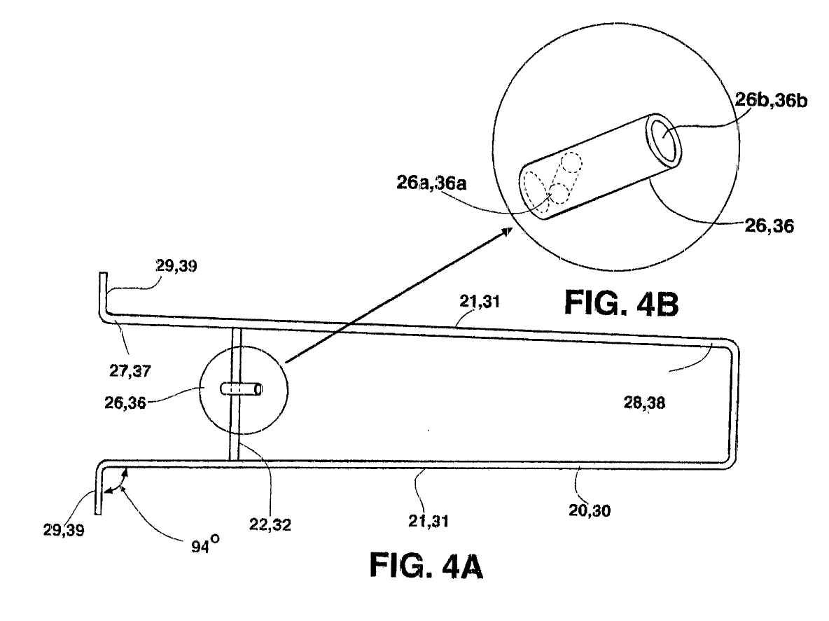

Referring now to FIG. 4, holding frames 30, 40 are similarly formed/bent, from a single piece of 0.5 cm stainless steel wire, into a generally U-shape (or other shape as desired for particular clothing). Holding frames 20, 30 are each approximately 15 inches long. Holding frame brackets 22, 32 are also formed from 0.5 cm stainless steel wire and are welded between legs 21,31 of the holding frames approximately 3.5 inches from the frame's lower ends 27, 37. Pivot tips, 29, 39 are formed at an angle of approximately 94 degrees with respect to the legs. Lower ends 27, 37 of the holding frames have a width of approximately 7.5 inches including pivot tips 29, 39, each tip being approximately 1 inch long. Upper ends 28, 38, where apparel, such as a boot, may be fitted for drying, have a nominal width of 3.5 inches.

FIG. 4 also shows detail of “detachable” connectors 26,36, also formed from stainless steel tubing, wherein “detachable connector” means that the support arms may be installed in the connectors 26, 36 when the apparatus is set up and then detached or removed from the connectors 26, 36 when the apparatus is collapsed. Again, the axial bore 26b, 36b of these connectors is slightly larger than 0.5 cm so that support arms 40, 50 may easily removed from the connectors. These connectors also have a diametrical bore 26a, 36a to receive cross-member 16. This diametrical bore also is slightly larger than 0.5 cm to permit the connector to easily pivot about the cross-member to accommodate the movement of the holding frames from their in use configuration to their stored positions.

In an alternative embodiment (not shown), longer holding frames, or extensions (not shown) to frames 20, 30, may be provided to accommodate large items such has hip waders. Frame extensions may be designed to be removable by slipping over the holding frames.

In another alternate embodiment, only one holding frame 20 with support arm 40 is used.

Preferably, in all embodiments, support arms 40, 50 may be either pivotally connected to base cross member 16, or to holding frame brackets 22, 32. If one end of the support arms 40, 50 is pivotally connected, the other end must be removably connected. In another alternate embodiment, one holding frame 20 with one support arm 40 is used, and another, second holding frame 30 is used. In this latter embodiment however, no second support arm 50 is used, instead, the second holding frame 30 is designed to be supported by the first holding frame 20 by leaning on it, or the apparel hanging from it.

In applications where compact storage is unnecessary, an alternative embodiment is provided where the pivoting means and connectors are replaced with welded joints.

Although this invention has been described above with reference to particular means, materials and embodiments, it is to be understood that the invention is not limited to these disclosed particulars, but extends instead to all equivalents within the scope of the following claims.

I claim:

1. An apparel drying apparatus, comprising:
a generally flat base with two base ends;
a base cross member approximately midway between the two base ends;
an apparel holding frame pivotally connected to one of said base ends;
a support arm with two arm ends, one end being removably connected to the apparel holding frame, and the other end being pivotally connected to the base cross member.

2. The drying apparatus of claim 1 which comprises two apparel holding frames, that are first and second apparel holding frames, the first frame being pivotally connected to one end of said base, and the second frame being pivotally connected to the other end of the said base.

3. The drying apparatus of claim 2 which comprises two support arms, that are first and second support arms, the first support arm being removably connected to the first apparel holding frame, and the second support arm being removably connected to the second apparel holding frame.

4. The drying apparatus of claim 2 which comprises two support arms, that are first and second support arms, the first support arm being removably connected to the first apparel holding frame, and the second support arm being removably connected to the base cross member.

5. The drying apparatus of claim 1 wherein said apparel holding frame is generally a flat U-shaped member for being inserted into a boot.

6. The drying apparatus of claim 1 wherein the apparel holding frame pivots to a position at an angle to the base in the range of 45-80 degrees, and is held at said position by said support art being removably connected to the apparel holding frame.

7. The drying apparatus of claim 6, wherein said base is an open frame comprising said two base ends and two side members in a generally rectangular shape, and said apparel holding frame is a U-shaped member upending from the base and adapted for being inserted into a boot.

8. An apparel drying apparatus comprising:
a generally flat base with two base ends;
a base crossmember approximately midway between the two base ends;
an apparel holding frame pivotally connected to one of said base ends;
a support arm with two arm ends, one end being pivotally connected to the apparel holding frame, and the other end being removably connected to the base crossmember.

9. The drying apparatus of claim 8 which comprises two apparel holding frame that are first and second apparel holding frames, the first frame being pivotally connected to one end of said base, and the second frame being pivotally connected to the other end of said base.

10. The drying apparatus of claim 8 which comprises two support arms that are first and second support arms, the first support arm being pivotally connected to the first apparel holding frame, and the second support arm being pivotally connected to the second apparel holding frame.
